(19) United States
(12) Patent Application Publication
(10) Pub. No.: US 2025/0380298 A1
(43) Pub. Date: Dec. 11, 2025

(54) TRIGGERING SENSING OPERATIONS PERFORMED BY A WIRELESS COMMUNICATIONS SYSTEM

(71) Applicant: Lenovo (Singapore) Pte Limited, Singapore (SG)

(72) Inventors: Robin Rajan THOMAS, Bad Nauheim (DE); Seyedomid TAGHIZADEH MOTLAGH, Oberursel (DE); Genadi VELEV, Darmstadt (DE)

(21) Appl. No.: 18/737,456

(22) Filed: Jun. 7, 2024

(51) Int. Cl. H04W 74/0808; H04L 5/00; H04W 24/10

(52) U.S. Cl. CPC H04W 74/0808; H04L 5/0051; H04W 24/10

(57) ABSTRACT

Various aspects of the present disclosure provide a sensing management component (SMC), which can be located or other placed within a radio access network (RAN) architecture, such as within an NG-RAN node or user equipment (UE). The SMC, which may communicate with a sensing function of a core network, facilitates or supports new or enhanced sensing requests or triggers, such as requests that originate from RAN nodes and/or UEs and are associated with sensing operations performed by the SMC.

### TECHNICAL FIELD

The present disclosure relates to wireless communications, and more specifically to triggering sensing operations performed by a wireless communication system.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system, via the various communication devices, can perform radio sensing to improve network performance and/or serve various use cases or associated services. Radio sensing operates to obtain environment information by using radio-frequency (RF) signaling to detect objects or areas within an environment, such as a physical location or environment that includes a UE or other user devices.

For example, a radio sensing mechanism, scheme, or technique can include: transmission of a sensing excitation signal (e.g., a sensing reference signal (RS)) from a sensing Tx node (e.g., a network entity or UE), reception of reflections/echoes of the transmitted sensing excitation signal from the environment by a sensing Rx node (e.g., a network entity or UE), and/or processing of the received reflections to infer information from the environment or objects within the environment.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support managing sensing components for a wireless communications system.

Some implementations of the method and apparatuses described herein may further include a network function for wireless communication, comprising at least one memory; and at least one processor coupled with the at least one memory and configured to cause the network function to receive a request to perform a sensing operation, wherein the request identifies a request type and comprises a sensing quality of service (QOS), determine a sensing mode for the sensing operation based on the request type, transmit one or more sensing reference signal configurations to one or more radio access nodes (RANs), and receive, from the one or more RANs, sensing measurements based on the one or more RANs performing the sensing operations.

In some implementations of the method and apparatuses described herein, the at least one processor is further configured to cause the network function to determine a sensing result based on the sensing measurements received from the one or more RANs and transmit the determined sensing result to an entity that requested the sensing operation.

In some implementations of the method and apparatuses described herein, the request type includes: a RAN induced sensing request (RI-SR), an entity terminated sensing request (ET-SR), a mobile originated sensing request (MO-SR), a network induced sensing request (NI-SR), a deferred sensing request, a UE sensing request (UE-SR), or combinations thereof.

In some implementations of the method and apparatuses described herein, the RI-SR comprises sensing operations for RAN functions.

In some implementations of the method and apparatuses described herein, the sensing QoS comprises: sensing accuracy, detection range resolution, range accuracy, direction or angle accuracy, doppler resolution and accuracy, update rate, beamwidth, false alarm rate, probability of detection, clutter rejection metrics, coverage area, azimuth or elevation coverage, sensing response time, sensing latency metrics, sensing reliability metrics, or combinations thereof.

In some implementations of the method and apparatuses described herein, the network function includes a sensing management component (SMC).

In some implementations of the method and apparatuses described herein, the network function is a location management function (LMF) that manages requests to perform sensing operations.

In some implementations of the method and apparatuses described herein, the network function is a RAN node performing sensing transmissions during the sensing operations and exchanges information with a UE performing sensing reception during the sensing operations via UE-RAN signaling mechanisms.

In some implementations of the method and apparatuses described herein, the network function is a RAN node performing sensing transmissions during the sensing operations and exchanges information with a different RAN node performing sensing reception during the sensing operations via RAN-RAN signaling mechanisms.

In some implementations of the method and apparatuses described herein, the at least one processor is configured to cause the network function to transmit one or more sensing reference signal configurations to the one or more RANs via a message transfer function that supports capability exchange, transmission-reception point (TRP) information exchange, or sensing information exchange.

In some implementations of the method and apparatuses described herein, the network function is an access and mobility management function (AMF) and selects a RAN node, from the one or more RANs, which includes an SMC to manage requests to perform sensing operations.

In some implementations of the method and apparatuses described herein, the at least one processor is configured to cause the network function to transmit a first sensing reference signal configuration to a RAN node that includes an SMC when the sensing operation is associated with a high sensing QoS and transmit a second sensing reference signal configuration to a function of a CN when the sensing operation is associated with a low sensing QoS.

In some implementations of the method and apparatuses described herein, the at least one processor is configured to cause the network function to transmit the one or more sensing reference signal configurations to a RAN node and centralized network function of a CN.

Some implementations of the method and apparatuses described herein may further include a method performed by a network function, the method comprising: receiving a request to perform a sensing operation, wherein the request identifies a request type and a sensing QOS, determining a sensing mode for the sensing operation based on the request type, transmitting one or more sensing reference signal configurations to one or more RANs, and receiving, from the one or more RANs, sensing measurements based on the one or more RANs performing the sensing operations.

In some implementations of the method and apparatuses described herein, the method further comprises determining a sensing result based on the sensing measurements received from the one or more RANs and transmitting the determine sensing result to an entity that requested the sensing operation.

In some implementations of the method and apparatuses described herein, the request type includes an RI-SR, an ET-SR, an MO-SR, an NI-SR, a deferred sensing request, a UE-SR, or combinations thereof.

In some implementations of the method and apparatuses described herein, the RI-SR comprises sensing operations for RAN functions.

Some implementations of the method and apparatuses described herein may further include network function for wireless communication, comprising at least one memory and at least one processor coupled with the at least one memory and configured to cause the network function to receive a request to perform a sensing operation from a RAN, transmit one or more sensing reference signal configurations to one or more RANs in response to the received request, and receive, from the one or more RANs, sensing measurements based on the one or more RANs performing the sensing operations.

In some implementations of the method and apparatuses described herein, the network function is an SMC that receives an RI-SR from the RAN.

Some implementations of the method and apparatuses described herein may further include a method performed by a network function, the method comprising receiving a request to perform a sensing operation from a RAN, transmitting one or more sensing reference signal configurations to one or more RANs in response to the received request, and receiving, from the one or more RANs, sensing measurements based on the one or more RANs performing the sensing operations.

### BRIEF DESCRIPTION OF THE DRAWINGS

FIG. 1 illustrates an example of a wireless communications system in accordance with aspects of the present disclosure.

FIGS. 2A-2B illustrate example block diagrams that depict performing radio sensing operations between nodes of a wireless communications system in accordance with aspects of the present disclosure.

FIG. 3 illustrates an example diagram that depicts an SMC as a separate logical node of a RAN in accordance with aspects of the present disclosure.

FIG. 4 illustrates an example diagram that depicts an SMC in a split base station in accordance with aspects of the present disclosure.

FIG. 5 illustrates an example diagram that depicts an SMC as an internal logical node of a RAN in accordance with aspects of the present disclosure.

FIG. 6 illustrates an example diagram that depicts an SMC as an internal logical function within a UE in accordance with aspects of the present disclosure.

FIGS. 7A-7C illustrate example diagrams that depict call flow procedures associated with an SMC in accordance with aspects of the present disclosure.

FIG. 8 illustrates an example diagram that depicts a call flow procedure for an SMC within a UE in accordance with aspects of the present disclosure.

FIGS. 9A-9B illustrate example diagrams that depict signaling between a UE and a RAN having an SMC in accordance with aspects of the present disclosure.

FIGS. 10A-10D illustrate example diagrams that depict signaling between RAN nodes having an SMC in accordance with aspects of the present disclosure.

FIG. 11 illustrates an example diagram that depicts signaling between a UE having an SMC and other UEs in accordance with aspects of the present disclosure.

FIG. 12 illustrates an example of a user equipment (UE) in accordance with aspects of the present disclosure.

FIG. 13 illustrates an example of a processor in accordance with aspects of the present disclosure.

FIG. 14 illustrates an example of a network equipment (NE) in accordance with aspects of the present disclosure.

FIG. 15 illustrates a flowchart of a method performed by an NE in accordance with aspects of the present disclosure.

FIG. 16 illustrates a flowchart of a method performed by a UE in accordance with aspects of the present disclosure.

### DETAILED DESCRIPTION

The technology is directed to messaging or signaling exchanges between user devices and network entities that facilitate the initiation, performance, and/or analysis of radio sensing operations within a wireless communications system. These radio sensing operations may support use cases such as human/object detection, weather monitoring and tracking, automotive sensing, sensing of positioning information, and so on.

However, for certain use cases (e.g., tracking), network delays and other latencies that arise within a network can lead to various issues or sub-optimal results, such as issues that affect the accuracy of tracking and reporting changes to a tracked objects orientation, position, and/or mobility.

For example, current implementations may introduce or place a sensing function (SF) in a core network (CN). Such a placement can inherently realize undesirable network latency (e.g., an end-to-end latency of computing sensing results that includes physical layer latency, layer-2 latency, and CN latency), because the sensing function is within the CN and not proximate and/or closer to target objects being tracked or otherwise part of associated sensing operations.

The systems and methods, therefore, introduce a sensing management component (SMC), which can be located or otherwise placed within a radio access network (RAN) architecture, such as within an NG-RAN node or UE. The SMC, which may communicate with the SF of the CN, enables a wireless communications system to perform certain sensing operations from the RAN node or UE, which are near or proximate to devices (e.g., UEs or base stations) that perform the sensing operations.

Further, the systems and methods introduce and/or support new or enhanced sensing requests or triggers, such as requests that originate from RAN nodes and/or UEs. In doing so, the systems and methods, via the SMC and enhanced communications/signaling between the SMC and the SF, can establish a low latency sensing operation (e.g., Integrated Sensing and Communication, or ISAC) for a wireless communications system, among other benefits.

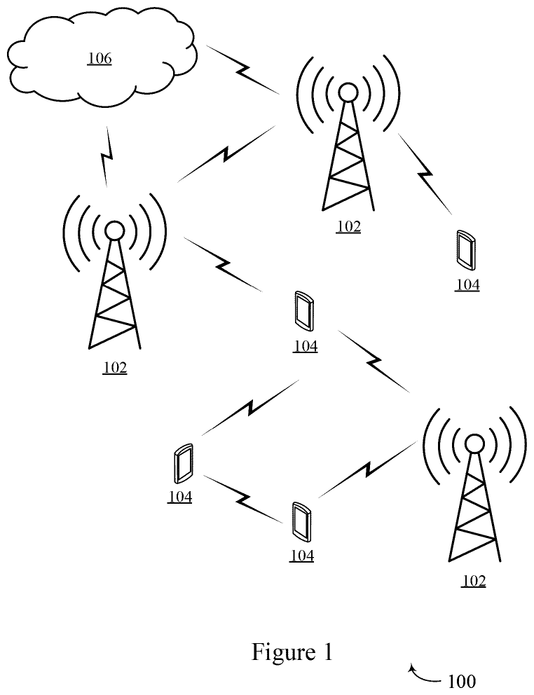

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

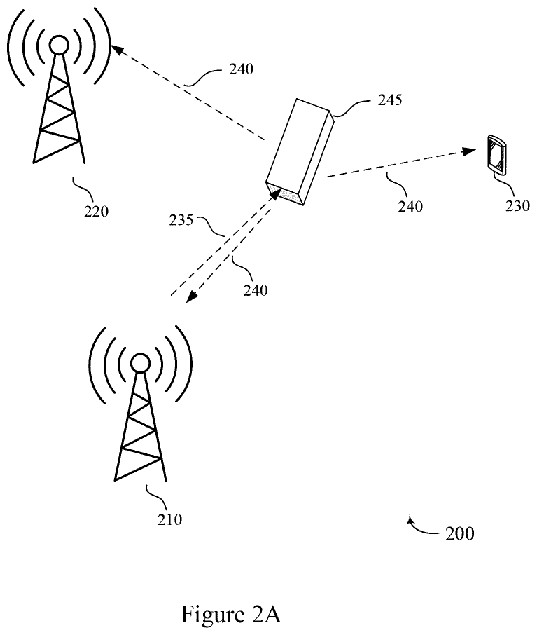

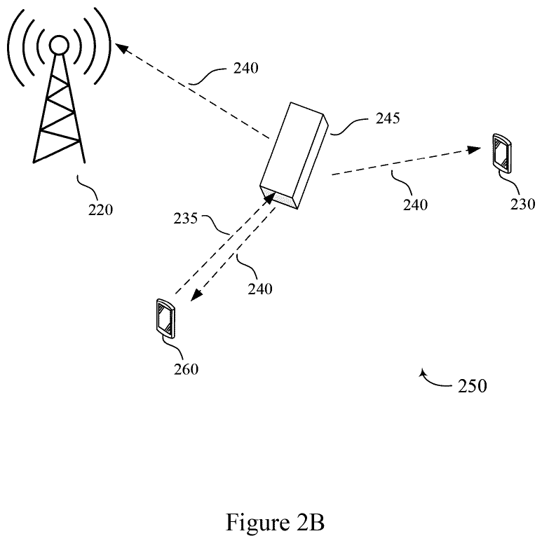

In some embodiments, the wireless communications system 100 supports the implementation of radio sensing operations initiated by the UEs 104 and performed by different nodes of the system 100, such as the NEs 102 and/or the UEs 104. FIGS. 2A-2B illustrate examples of block diagrams that support performing radio sensing operations between nodes of a wireless communications system in accordance with aspects of the present disclosure. For example, FIG. 2A depicts a radio sensing operation 200 performed between a base station or other network entity 210 acting as a Tx node, and another base station 220 or a UE 230 acting as a Rx node.

As a first example of the radio sensing operation 200, the base station 210 transmits a sensing RS 235, which reflects off an object 245, resulting in a received RS 240 that is received by one or more network entities, such as the base station 220 or the UE 230. The network can indicate the sensing RS 235 to other (non-network) nodes or a subset of the UE nodes via a MAC CE, new sensing protocol signaling, Radio Resource Control (RRC) signaling, Physical Downlink Shared Channel (PDSCH) or Physical Downlink Control Channel (PDCCH)/Downlink Control Element (DCI) signaling or a group-common DCI.

For example, the network can signal the other resources via group-common DCI when the sensing RS 235 occupies resources similar to other physical channels, and hence, the indication of the sensing RS 235 is used to suppress the received RS 240 by nodes other than sensing Rx nodes, or used as an indication of sensing-dedicated resources where some of the physical channels are not be present/interfered with, or to mute transmissions taking place at the same resource to protect the sensing operation, for the purpose of interference measurements from the sensing Tx towards the UE nodes or other network devices, and/or where the sensing RS 235 is indicated to be re-used for other purposes (e.g., as an RS to track some CSI/environment information) by the UE devices.

In some cases, the assignment of the sensing RS 235 includes implicit information on the utilized waveform parameters (e.g., CP/guard-band length for the UE nodes, the type of the required sensing processing and reporting procedure, and so on).

As another example of the radio sensing operation 200, the base station 210 transmits and receives the sensing RS 235 (e.g., receives the RS 240), utilizing proper duplexing capability (e.g., full-duplex) to enable reception of the echoes/reflections transmitted by the same node. In some cases, the network indicates the utilized sensing RS 235 to other (non-network) nodes or a subset of the UE nodes via a MAC CE, new sensing protocol signaling, RRC signaling, PDSCH or PDCCH/DCI signaling or a group-common DCI.

In some cases, when the sensing RS 235 and some of the physical DL channels share the same resources, the adjustments on the physical DL channels are indicated to the relevant UE nodes (e.g., the use of additional DMRS (demodulation reference signal) patterns to support beam variations in case of the beam sweeping combined with the DL transmissions).

As another example of the radio sensing operation 200, the base station 210 transmits the sensing RS 235 and the UE 230 (or multiple UEs) receives the reflected RS 240. The network indicates (implicitly or via direct assignment) the UE 230 to operate as the sensing Rx, including (but not limited to) a definition of the sensing RS 235, a type of the sensing measurements, and/or a reporting strategy and reporting resources. The base station 210 can signal the UE 230 via a MAC CE, new sensing protocol signaling, RRC or dynamically via PDCCH/DCI, group-common DCI, and/or via a part of the sensing RS 235.

In some cases, the base station 210 communicates the information regarding the sensing RS 235 to other UE nodes (e.g., the base station 220), which are not a sensing Rx, using the various signaling methods described herein. Non-sensing-Rx UEs can utilize the sensing RS 235 information to comply with an updated waveform parameter due to sensing (e.g., the modification of CP/guard-bands during active sensing periods).

As another example, FIG. 2B depicts a radio sensing operation 250 performed between a UE 260 acting as a Tx node, and another base station 220 or a UE 230 acting as a Rx node.

As a first example of the radio sensing operation 250, the UE 260 transmits the sensing RS 235, which reflects the RS 240 to the base station. The network can indicate (implicitly or via direct assignment) the UE 260 to operate as the sensing Tx, including the definition of the sensing RS 235. The network signals the entities via a MAC CE, new sensing protocol signaling, RRC or dynamically via PDCCH/DCI, group-common DCI, and/or via a part of the sensing RS 235.

In some cases, the network communicates information regarding the sensing RS 235 shall be communicated to other UE nodes, which do not perform as a sensing Rx, using the signaling methods described herein. The non-Sensing Rx UEs can utilize the sensing RS 235 information for successive interference reduction, when the same resources are also used for DL or SL communications. Further, the non-Sensing Rx UEs can utilize the sensing RS 235 information to comply with an updated waveform parameter due to sensing (e.g., modification of CP/guard-bands during active sensing periods).

As another example of the radio sensing operation 250, the UE 260 transmits the sensing RS 235, which reflects off the object 245, and the RS 240 is received by another UE node, such as the UE 230. The network can indicate (implicitly or via direct assignment) the UE 230 to operate as the sensing Rx and the UE 260 to operate as the sensing Tx, as well as define the sensing RS 235, the type of the sensing measurements, and/or reporting strategy and reporting resources.

As described herein, the network signals the entities via a MAC CE, new sensing protocol signaling, RRC or dynamically via PDCCH/DCI, group-common DCI, and/or via a part of the sensing RS 235. In some cases, the network communicates information regarding the sensing RS 235 to other UE nodes, which do not perform as a sensing Rx, using the signaling described herein.

As another example of the radio sensing operation 250, the UE 260 transmits the sensing RS 235, which reflects off the object 245, and returns as the RS 240 to the UE 260. As described herein, the network utilizes various signaling methods to communicate information about the sensing RS 235 to the different entities, such as entities not performing the sensing Rx.

In some embodiments, the technology described herein provides messaging and/or signaling to enable or support the performance of radio sensing operations, such as sensing operations associated with an SMC located in an NG-RAN (e.g., in a RAN node or UE) as depicted in FIGS. 2A-2B and the associated examples.

As described herein, the systems and methods provide a new logical entity (e.g., the SMC), which handles radio sensing operations for a network. The systems and method also provide new interfaces between the logical entity and various network devices or components, such as interfaces between the SMC and nodes of the CN, the SMC and nodes of the NG-RAN, and so on. The interfaces, in various embodiments, facilitate the transmission of sensing-specific information to and between network functions, such as a sensing management function (SMF), a sensing function (SF), a location management function (LMF), and so on.

In some cases, the SMF and/or SF manages the overall coordination and scheduling of resources utilized for sensing operations, such as the sensing of an object/human. The SMF/SF may calculate or verify a final sensing result and/or any velocity or doppler estimates, and/or may estimate the achieved sensing accuracy for the sensing operation. In some cases, the SMF/SF receives sensing requests, for a target within a network area or location, by a sensing client, which may be external client or internal client with respect to the network. The SMF, in some implementations, interacts with various network entities and UEs in order to exchange location information applicable to UE assisted and/or UE based sensing operations and interacts with the NG-RAN to obtain sensing information.

In some embodiments, the SMC includes all or part of the functionality of the SMF and/or SF, and may reside in the NG-RAN or other network location separate or remote from the SMF/SF.

As described herein, the SMC may coordinate sensing operations and/or signaling between different entities, such as the SMC itself, the SMF/SF, base stations (e.g., gNBs or ng-eNBs), UEs, and so on. The SMC may provide a network with various improvements to signaling operations and/or architectures, such as by enabling the use of lower layer signaling for performing sensing operations, the use of nodes of different vendors, and so on. Such deployments (e.g., SMCs) may decouple the regular functions of RAN nodes from sensing functions, because the SMC can act to perform/manage the sensing operations in a private or exclusive function with respect to the operations of the RAN node that includes the SMC.

Further, the SMC facilitates and/or supports low latency signaling procedures by acting as a RAN node and transferring sensing related information (e.g., sensing results, UE sensing capabilities, sensing reports) using lower layer signaling with a UE (e.g., via an interface with a UE having an SMC).

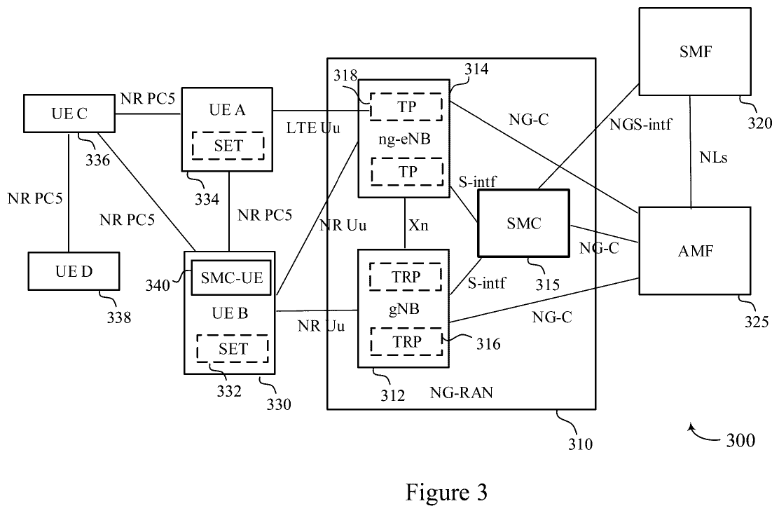

In some embodiments, the SMC is a separate logical component or entity that is connected to one or more NG-RAN nodes. FIG. 3 illustrates an example diagram 300 that depicts an SMC 315 as a separate logical node of a RAN 310 in accordance with aspects of the present disclosure.

The SMC 315 may perform various functions associated with sensing requests. For example, the SMC 315 supports the reception of different sensing requests as defined for an SMF 320 or any NF (e.g., an AMF 325) that is responsible for managing sensing-related services or operations, such as services related to requesting, collecting, and/or processing of sensing measurements, computation of sensing results, and so on.

The sensing requests may be received in one or more time domain transmissions: a one shot/dynamic/on-demand manner, in a request that requires sensing results computed in a periodic manner, in a request that requires sensing results in a semi-persistent manner (e.g., which may require activation/deactivation signaling).

In some cases, the sensing requests comprise of several parameters, including:

Sensing type/purpose, such as target object/human presence detection, immediate/periodic/semi-persistent target tracking, object identification (including object classification), target localization and tracking, link blockage detection, object cluster detection and/or tracking, AI/ML (artificial intelligence/machine learning) sensing modes; and so on;

Sensing quality of service (QOS)/requirements;

Area detection/tracking, such as requests to track/detect an object in a specific area defined by one or more combination of parameters including Cell Global ID (for LTE, NR or 6G), physical cell ID, Absolute Radio Frequency Carrier Number (ARFCN) ID, Area ID, tracking area, zone ID/zone area, and so on.

As another example, based on the information of the sensing requests, the SMC 315 discovers and selects transmission-reception points (TRPs). The discovery criteria may be based upon the deployment and may be implementation specific. In some cases, the TRPs are based on radio access or link criteria, including whether a target object is line-of-sight (LOS)/non-line-of-sight (NLOS), geometry of deployment, proximity of object to TRP (e.g., range/distance, direction, orientation, absolute/relative position), and so on.

As another example, the SMC 315 creates a sensing reference signal and/or measurements configuration information for selected TRPs. The sensing reference signal configuration is transmitted via a request to each of the radio access nodes/gNBs/base stations/TRPs for transmission characteristics, including sensing time-frequency resources, TRP ID, bandwidth, aggregated bandwidth request, TRP information (e.g., beam antenna information, antenna reference point information), sensing reference signal configuration (e.g., sensing reference signal resource ID, resource set, subcarrier spacing, start physical resource block (PRB), comb size, cyclic prefix, resource periodicity, resource slot offset, resource repetition factor, number of sensing RS symbols), spatial direction information, synchronization information, TRP type (sensing RS only communication and sensing RS, uplink sensing RS, downlink sensing RS), common timing advance for sensing, and/or the RAN node/gNBs/TRPs. The SMC 315 may receive a transmission characteristic response including the available radio resources and one or more of the requested parameters to be used for sensing and/or communication.

In some cases, the SMC 315 transmits the sensing reference signal measurement configuration via a request to each of the radio access nodes/gNBs/base stations/TRPs according to common or specific sensing methods/techniques, which derive sensing measurements, and receives responses based on the performed sensing measurements.

The SMC 315 may interact (e.g., send requests) with various RAN 310 nodes, including serving gNBs 312 and/or TRPs 316, ng-eNBs 314 and/or TPs 318, neighboring gNBs/TRPs, to transmit sensing measurements configuration information, which may comprise the request and reception of reports related to sensing measurements and/or sensing results using a dedicated sensing interface (e.g., S-intf) or other network interfaces (e.g., X-n interface, NRPPa interface, and so on).

In some cases, the SMC 315 calculates/computes sensing results or partial sensing result (e.g., the latter to be provided to the SMF 310 of the CN). The SMF 310 and/or a client requesting sensing operations may utilize sensing results to: track the movement of objects/beings, including obtaining velocity/speed and other mobility metrics, provide indications on the presence of objects/beings in a given area, determine a 2D/3D distance to an object/being relative to a sensing Tx (transmitter) and/or sensing Rx (receiver) or to a known reference point separate from the sensing, provide information on a type of object/being, provide information on a material of an object, provide information indicating a quality, confidence, and/or uncertainty with respect to various sensed information or metrics, and so on.

In some deployments, the coverage of the SMC 315 may be localized with respect to the coverage of the SMF 320 (or other SF or LMF) and/or the AMF 325, which are centralized network functions. Being localized, the SMC 215 may provide tight coordination with a group of base stations/TRPs in its smaller, localized area during sensing operations. For example, the localized area may be indoor area or specific outdoor area, covering multiple cell IDs, TRP IDs, and/or physical cell identities.

Thus, the SMF 320 may select and/or otherwise utilize the SMC 315, because the SMC 315 can sufficiently cover a particular target object/human during the sensing operations. The SMC 315 may also provide the base station IDs/TRP IDs as part of its local area coverage to the SMF 320, the AMF 325, or other sensing functions.

The sensing operations may capture or measure sensing results, including range information, doppler data (e.g., doppler information), information on the direction of movement, the velocity of an object, signal amplitude information, position/location information, information regarding the shape of the object, information regarding the material of the object, and so on.

As described herein, the SMC 315 may communicate with the RAN nodes (e.g., the gNB 312 and/or the ng-eNB 314) via a dedicated sensing interface, or S-intf. The S-inft may transmit the information, such as sensing measurements and/or result calculations) in a low latency or centralized manner (e.g., in a bistatic manner where different RAN nodes act as the Tx or Rx nodes).

In some cases, the SMC 315 may communicate with the SMF 320 via a dedicated interface (e.g., NGS-intf). The NGS-intf directly connects the SMC 315 to the SF 320 or other CN functions that handle sensing requests. Via the interface, the SMF 320 may select an SMC based on aspects of the sensing request (e.g., the target area or location), such as the sensing of targets/objects that are not part of the network.

As depicted, the SMC 315 is connected to the AMF 325 via an NG-C interface, although the AMF 325 may utilize a new interface to communicate with the SMC 315 (e.g., after selection of the SMC 315 from multiple available SMCs)

In some cases, the SMC 315 may act as a configuration entity for configuring reference signals and associated behaviors, such as setting the sensing reference signal transmission pattern, periodicity, number of symbols, frequency offset, slot offset, muting configuration, Subcarrier spacing, signal bandwidth, and so on.

In some cases, use of the SMC 315 enables a network to deploy sensing services across vendors, such as by utilizing RAN nodes from the same vendor or different vendors (e.g., an inter-operable vendor deployment).

In some embodiments, the use of multiple SMCs may lead to one SMC acting to handover sensing-related operations and/or sensing context/configurations to another SMC. Thus, a serving SMC may handover sensing-related operations and/or sensing context/configurations to a target SMC once a tracked object moves from the coverage area of the serving SMC to the coverage area of the target SMC.

The SMCs may utilize a new or dedicated interface during the handover (e.g., to transfer sensing context information to the target SMC). In some cases, a function of the CN (e.g., the AMF 325 or the SMF 320) may manage or handle the handover. The interface may carry control plane information and/or user plane information associated with sensing messages, such as capability information, configuration information, reporting, error information, and so on.

In some embodiments, the SMF 320 may select a specific gNB as a head or

serving gNB of a sensing task or operation, and the RAN controller entity for the sensing task or operation may be the SMC of the selected gNB. Prior to selection, capability information for available gNBs (e.g., coverage area, type of supported sensing measurements, supported sensing modes, and so on) is exchanged with the controller entity.

As shown in FIG. 3 various UEs (UE A 334, UE B 330, UE C 336, and UE D 338) may be associated with the RAN 310 and/or assist in performing sensing tasks/operations. The UEs may be configured as SUPL enabled terminals (SETs) 332 and support secure user plane (SUPL) transactions, such as the sending and receiving of assistance/positioning/sensing data with the RAN 310. One or more of the UEs (e.g., UE B 330) may include an SMC 340 (e.g., SMC-UE), which can perform the functions of an SMC (e.g., the SMC 315), as described herein. Further details regarding the SMC-UE are described herein.

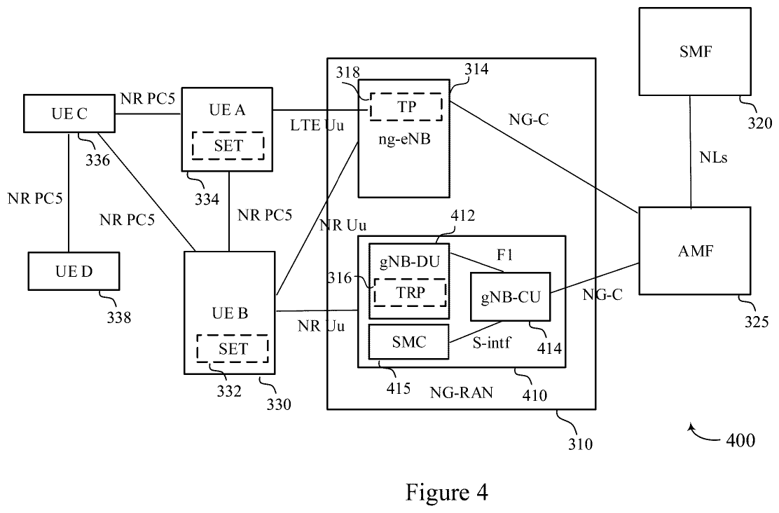

In some embodiments, the SMC is a logical node or entity within a split gNB. FIG. 4 illustrates an example diagram 400 that depicts an SMC 415 in a split base station 410 in accordance with aspects of the present disclosure. The SMC 415 is connected to a gNB-CU (centralized unit) 416 via a new and/or dedicated interface (e.g., S-intf) and a gNB-DU (distributed unit) 412 via a F1 interface. Thus, the SMC 415 acts as a logical node in a CU-DU split NG-RAHN architecture, which may be connected to the SMF 320.

In some cases, the S-intf between the gNB-CU 416 and the SMC 415 may handle sensing measurements and/or result calculations, such as measurements/calculations offloaded from the gNB-CU 416 in a low latency and semi-centralized manner (e.g., for bistatic cases, as described herein).

In some cases, the SMC 415 acts as a configuration entity for configuration sensing reference signals and associated behaviors during sensing services and/or operations. Further, the SMC 415 enables a network to deploy sensing services across vendors, such as by utilizing RAN nodes from the same vendor or different vendors (e.g., an inter-operable vendor deployment).

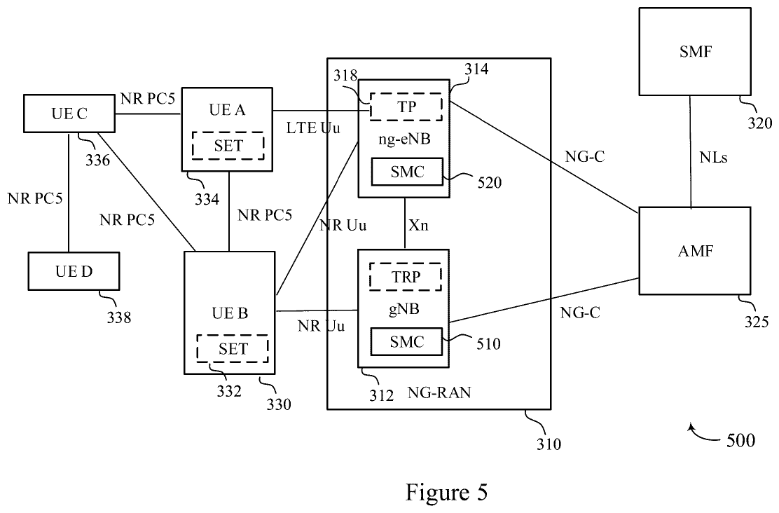

In some embodiments, the SMC may be part of a logical node of the RAN 310. FIG. 5 illustrates an example diagram 500 that depicts an SMC 510, 520 as an internal logical node of the RAN 310 in accordance with aspects of the present disclosure. For example, the gNB 312 may consider the SMC 510 as a sub-component of the gNB 312, and thus not require any additional external interfaces. Similarly, the ng-eNB 314 may consider the SMC 520 as a sub-component of the ng-eNB 314, and thus not require any additional external interfaces.

Being deployed as an internal network node, the SMC 510, 520 may enable sensing-related processing and functionality to be internal to a gNB or another NG-RAN node. In some cases, the processing of sensing measurements and sensing results may be distributed, leading to an increased load along the Xn interface due to handling of sensing related functionality (e.g., new messages and procedures for performing the XnAP handover preparation procedures).

In some cases, the centralized SMF 315 (or SF) may manage the sensing reference signal configuration for the sensing and collection of different sensing measurements from different NG-RAN nodes. The centralized SMF 315 may control the selection of a head/lead or serving NG-RAN node for a sensing task, where the selected NG-RAN node handles the reference signal configurations, measurement configuration and activation, measurement collection (e.g., implemented/performed via the SMC 510, 520 internal to the NG-RAN), and so on.

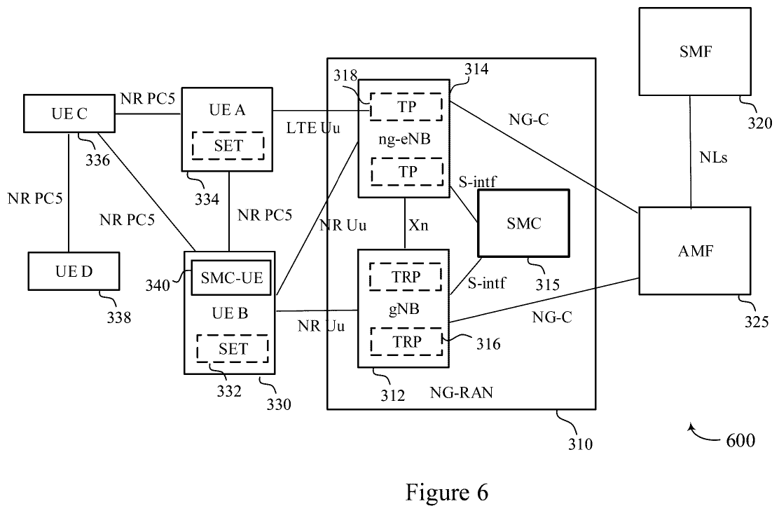

In some embodiments, the SMC may act as an internal logical function within a UE, performing sensing method determinations, sensing reference signal configuration for UE-UE links (e.g., a PC5 interface), sensing result calculations, and so on. FIG. 6 illustrates an example diagram that depicts the SMC 340 as an internal logical function within a UE in accordance with aspects of the present disclosure.

The SMC 340, or SMC-UE, may be a new internal logical component within a UE and/or a capability for a UE. The SMC-UE enables the UE B to discover, select, and/or request other UEs (UEs A, C, D) to assist and/or participate in a specific sensing task or operation, with the aim of collecting sensing results for a desired target object. Thus, a given NG-RAN node may consider the SMC 340 as a sub-component or logical function or role of the UE B, which performs sensing related operations/tasks.

In some cases, the UE B, having the SMC-UE, may include the capability of determining a sensing method, determining a sensing reference signal configuration, or assisting in data distribution and/or sensing result calculation functionalities for Uu and/or PC5 sensing services. The UE B can interact with other UEs over the PC5 interface to determine the sensing method, to distribute sensing reference signal configurations, assist in data distribution and/or calculate the sensing result of a target object/being of interest.

Thus, the SMC-UE may enable a UE (e.g., the UE B) to perform the functions of the SMC, as described herein, over a UE-UE interface (e.g., the Uu or PC5 signaling interfaces).

An SMC of a UE may be discovered using various discovery procedures, such as Model A (“I am here”) or Model B (“Who is there”/“Are you there”) type discovery. The discovery procedure may include “Discovery Announcement” messages for sensing-related services, “Discovery Solicitation” messages for sensing-related services, corresponding “Discovery Solicitation Response” messages in response to receiving the “Discovery Solicitation” messages, and so on.

In some cases, a UE may be discovered in multiple RRC states (e.g., RRC_CONNECTED, RRC_INACTIVE, and RRC_IDLE states). For example, in an RRC_CONNECTED state, the UE is always transmitting or monitoring sensing discovery-related messages or transmitting or monitoring sensing discovery-related messages with a finer granularity of periodicity (e.g., every few ms). However, in the RRC_INACTIVE state, the UE is transmitting or monitoring sensing discovery-related messages in intervals/periodicities greater than that of RRC_CONNECTED state (e.g., every 20 ms, every second), while for the RRC IDLE state the UE is transmitting or monitoring sensing discovery-related messages in intervals/periodicities greater than that of the RR CONNECTED and the RRC INACTIVE state (e.g., every 10 seconds or greater).

In some cases, a core network function or NG-RAN node (e.g., the SMC) may initiate the paging process for the purpose of sensing or based on sensing-related triggers, while the UE is RRC INACTIVE or RRC_IDLE state. The UE may trigger the paging process for sensing-related purposes. Also, the UE may wake up at pre-defined intervals to monitor for sensing-related paging messages or transmit sensing-related signals, referred to as DRX intervals.

In some cases, the UE B may be authorized to perform as an SMC based on its capabilities. For network-based sending, the SMF 320 may select the UE, based on associated capabilities, to act as a sensing Tx or Rx node. A UE with SMC functionality (e.g., the UE B and associated SMC 340) may receive reference signal configurations/assistance information to enable a sensing result calculation from the SMF 320 or a network function responsible for handling sensing requests (e.g., an LMF).

In some cases, the UE B and associated SMC 340 may coordinate with other UEs and/or the network to perform sensing reference signal configuration delivery, sensing reference signal transmission, the configuration of sensing measurements and reports, and other tasks or operations.

As described herein, the SMC may handle joint or integrated sensing and localization/positioning operations or procedures. The SMC, in some cases, may be referred to as an SMC+LMC (location management component) and/or an integrated SMC, reflecting the following capabilities:

The joint handling of sensing requests (SRs) and location requests (LRs) received from an external/internal client/application function (AF) or any NF responsible for managing both location-related and sensing-related services (e.g., requests, collecting and processing of sensing/location (positioning) measurements, computation of the positioning/sensing results, and so on); and

The interaction with the various NG-RAN nodes, including serving gNBs/TRPs, neighboring gNB/TRPs, to request and receive reports related to joint sensing, location/positioning measurements, and/or sensing/positioning results.

Thus, the SMC-LMC may include the following functionality:

An ability to calculate the location/position information of an object, where the SMC can support location/positioning computation of the desired object/human, which depends of the size characteristics of the object and reference location to which the location/information position information of the object is described (e.g., absolute/relative 2D/3D location/position with respect to the defined point of the object (e.g., center point of the object)), or any term that defines an intermediate universal Geographical Area Description of which subscriber applications (e.g., GSM, UMTS, EPS, 5GS, 6GS services) can use and the network can convert into an equivalent radio coverage map, such as a reference system, shape descriptions (e.g., ellipsoid point with/without uncertainty, ellipsoid arc, polygon, and so forth) and associated codepoints for each shape description;

An ability to calculate the location/position information of the UE required to assist or participate in a sensing task, depending on the deployment and/or sensing type/purpose. This provides the SMC with an additional degree of freedom to act as an LMC and calculate UE positions without triggering the same location procedures in a separate entity (e.g., as in legacy location procedures involving the LMF).

In some cases, the location information result may include a 2D/3D absolute/relative position of an object equipped with the UE, a 2D/3D range with respect to a transmitter (e.g., UE, gNB/TRP) and receiver (e.g., UE, gNB/TRP) associated with a sensing object or nearby sensing object, positioning Integrity information related to the computed/estimated position/location, and so on.

As described herein, in some embodiments, the frameworks and/or architectures employ an SMC as part of a RAN node or associated UE. The frameworks may support the handling and/or management of various sensing requests, including sensing requests that originate from the RAN and/or requests received by the CN, such as by the SMF or other network functions (e.g., from external clients).

The SMC frameworks/architectures may support the receipt and/or handling of different sensing requests, such as:

A RAN Induced Sensing Request (RI-SR), where the SMC supports sensing service requests from functions internal to the NG-RAN node. In some cases, the SMC can handle such requests locally (e.g., inside the RAN);

An Entity Terminated Sensing Requests (ET-SR), where a sensing service consumer/client or AF external to or internal to a serving Public Land Mobile Network (PLMN) sends a sensing request to a PLMN (which may be a Home PLMN (HPLMN) or Visited PLMN (VPLMN) for the sensing related information or sensing result of a target/being of interest;

A Mobile Originated Sensing Requests (MO-SR), where a UE sends a request to a serving PLMN for the sensing related information or sensing result of a target/being of interest; and/or

A Network Induced Sensing Requests (NI-SR)-where a serving AMF or other NF for one or more target sensing object(s)/being(s) of interest initiates sensing operations for certain services (e.g., a regulatory service, such as an emergency request to sense an object).

Each of the types of sensing requests may include sub-types, including:

An Immediate Sensing Request, where a sensing client or AF transmits or instigates a sensing request for one or more target sensing object(s)/being(s) of interest and expects to receive a response containing sensing-related information for the one or more target sensing object(s)/being(s) of interest immediately or within a short pre-defined time period, which may be specified using QoS/KPIs associated with the sensing request. In some cases, certain services may request one or more responses of the one or more target sensing object(s)/being(s) of interest, including sensing information. An MT-SR, MO-SR, and/or NI-SR may include or be an immediate sensing request;

A Deferred Sensing Request, where a sensing client or AF sends a sensing request to a PLMN for one or more target sensing object(s)/being(s) of interest and expects to receive a response containing the indication of event occurrence and sensing information if requested for the one or more target sensing object(s)/being(s) of interest at some future time period/time instances, which may be associated with specific events associated with the one or more target sensing object(s)/being(s) of interest. An MT-SR, MO-SR, or NI-SR may support deferred sensing requests.

In some cases, certain events may trigger deferred sensing requests, including:

Time-based events: sensing requests and responses are triggered at a certain future time (e.g., configured in terms of a standardized time, such as UTC time, GNSS time, network time, and so on). In some cases, a timer may trigger such sensing requests and/or receive a sensing result (e.g., upon expiry of a timer or upon initiation of timer). In some cases, a sensing result may be triggered at periodic intervals or at subsets of certain periodic intervals;

Area-based events: sensing results are triggered based on certain area events (e.g., one or more target sensing object(s)/being(s) of interest entering/leaving a specific geographic area (e.g., tracking area, ran notification area, ran system information area), PCI, NCGI, pre-defined zones, leaving a pre-defined list of cells, and so on;

UE presence: sensing results are triggered based on the proximity of one or more target sensing object(s)/being(s) of interest to a particular UE. If one or more target sensing object(s)/being(s) of interest are near to a specific UE (in terms absolute/relative location, distance to the UE, relative direction to a UE, and so on), sensing results may be triggered;

Target Object/Being Motion: sensing results are triggered based on the motion of one or more target sensing object(s)/being(s) of interest. For example, if the target sensing object(s)/being(s) of interest moves with a certain velocity according to a threshold or range, a certain acceleration according to a threshold or range, moves in the certain heading/direction according to a pre-defined direction, moves with a certain geometric motion, straight line or circular motion or oval motion in 2D/3D space, sensing results may be triggered;

Target Object/Being Type: sensing results are triggered based on the type or shape of one or more target sensing object(s)/being(s) of interest (e.g., based on a list of pre-defined shapes or types or object material types); and so on.

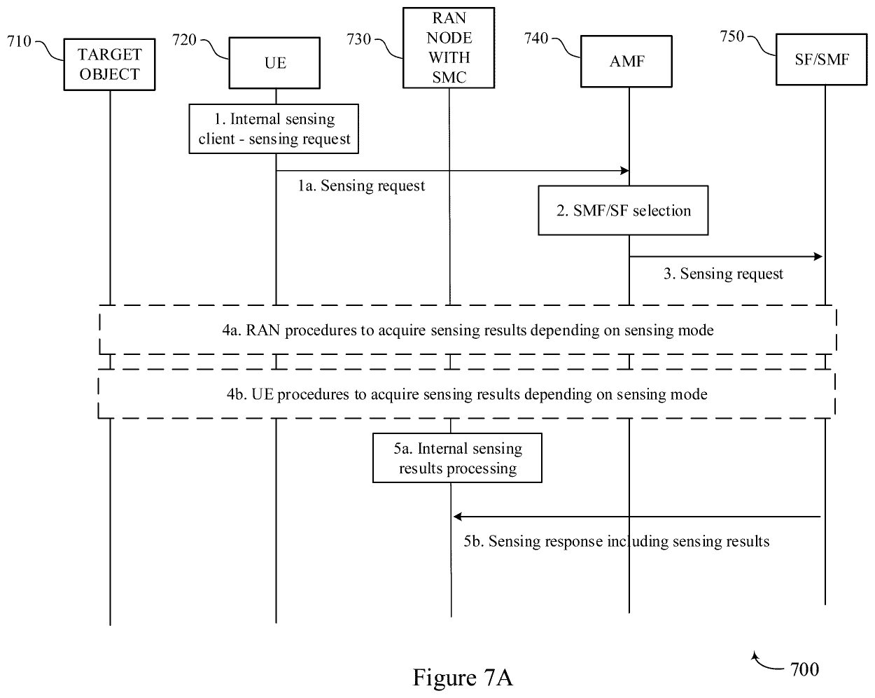

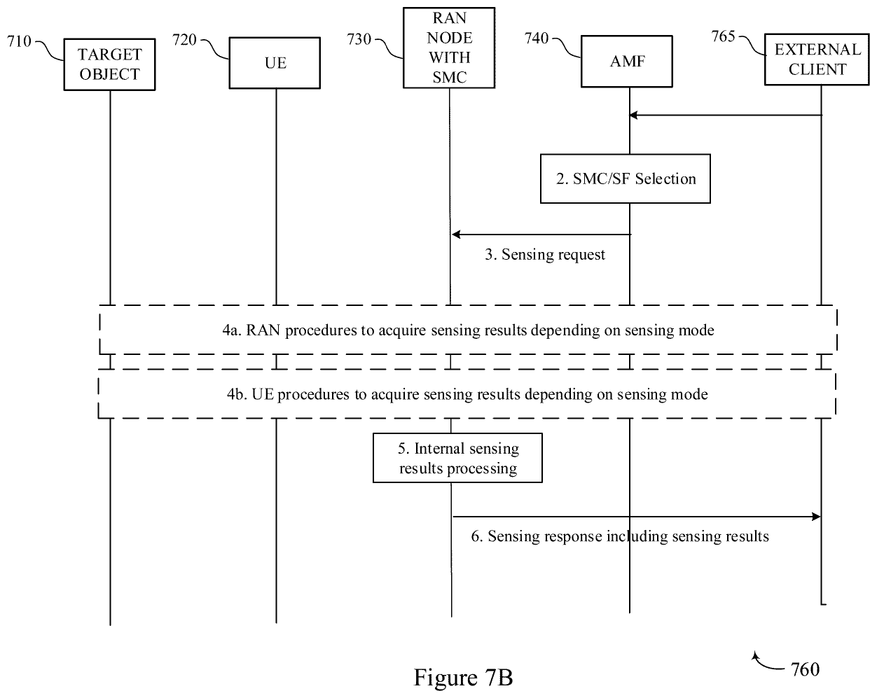

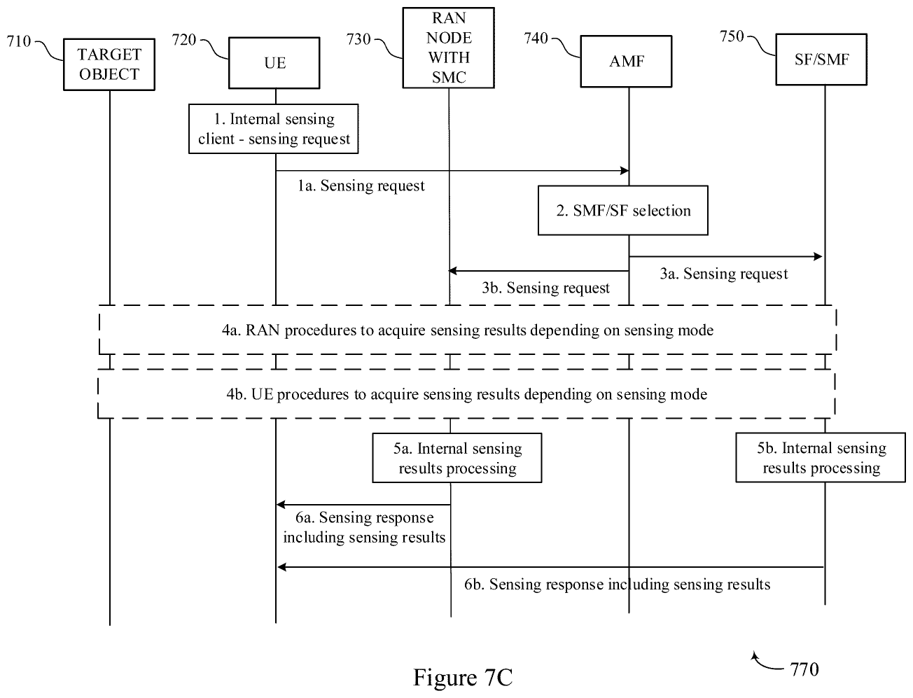

FIGS. 7A-7C illustrate example diagrams that depict call flow procedures associated with an SMC in accordance with aspects of the present disclosure. The call flow procedures may be between a target object 710, a UE 720, a RAN node 730 (with an SMC), an AMF 740, an SF/SMF 750, and/or an external client 756. FIG. 7A depicts a call flow 700 for the RI-SR.

In step 1, one or more RAN functions (e.g., beam management, radio resource management (RRM), minimization of drive test (MDT) in the RAN node 730, requests one or more sensing services related to sensing a target object/being, each associated with sensing requirements or sensing QoS, which is triggered internally. In step 1a, the SMC of the RAN node 730 may also transmit the same sensing request to the AMF 740 to be shared with the SF/SMF 750, which handles sensing requests.

In some cases, the sensing request is issued by a RAN node towards an available SMC to the RAN node (e.g., either internal to the RAN node or at another RAN node accessible to the first RAN node), including an indication of the requested sensing task/type. The sensing request may be issued towards the SF/SMF 750, which is available to the RAN node 730. The sensing QOS may include one or more of: sensing accuracy, detection range resolution, range accuracy, direction/angle (azimuth/elevation) accuracy, doppler resolution and accuracy, update rate, beamwidth, false alarm rate, probability of detection, clutter rejection metric, coverage area, azimuth or elevation coverage, sensing response time, metrics related to sensing latency, metrics related to sensing reliability, and so on.

In step 2, the AMF 740, if available, selects a SF/SMF 750, which is responsible for handling sensing requests (e.g., an SMF/SF to coordinate the sensing request and sensing related service with the SMC) based on various configurations known by the SMC/SF/SMF/NF responsible for handling the sensing requests. For example, the SMF/SF may track the NG-RAN node sensing management capabilities for different SMCs.

In step 3, once selected, the AMF 740 forwards the sensing request to the serving SMF/SF 750 responsible for handling sensing requests.

In steps 4a-4b, the serving SMF/SF 750, together with the NG-RAN node 730 with the SMC, determines the sensing mode based on the received capability information (e.g., supported sensing methods, sensing quality of service, and so on). For example, in step 4a, sensing procedures with the involved NG-RAN nodes, such as bistatic sensing where one NG-RAN node may act as a sensing Tx and one or more NG-RAN nodes may act as a sensing Rx, are initiated as described herein. As another example, in step 4b, sensing procedures with the involved NG-RAN nodes and the UE 720 (e.g., bistatic sensing where one NG-RAN node may act as a sensing Tx and one or more UEs may act as a sensing Rx) are initiated as described herein.

In step 5a, The SMC collects the sensing measurements from all NG-RAN nodes and UEs and computes the required sensing results. In step 5a, the SMC internally forwards the sensing results to the applicable sensing NG-RAN nodes. In step 5b, the SMC receives a consolidated set of sensing results from the SF/SMF 750 and internally forwards the sensing results to the applicable sensing NG-RAN nodes.

As described herein, in addition to sensing measurements and results, the call flow 700 may also support positioning measurements and location estimates transferred along with the sensing measurements and results in a coordinated fashion.

FIG. 7B depicts a call flow 760 for the ET-SR. In step 1, a sensing service entity (e.g., a Gateway Mobile Location Center, or GMLC), or the external client 765 requests one or more sensing services for a target object 710 to the serving AMF 740, with each requested service being associated with sensing requirements or sensing QoS.

In step 2, the AMF 740 selects an available SMC/SF/SMF/NF responsible for handling sensing requests in the geographic area of the target sensing object/being of interest, in order to coordinate the sensing procedures, based on various configurations known by the SMC/SF/SMF/NF (e.g., sensing management capabilities amongst different SMCs).

In step 3, the AMF 740 forwards the sensing request to the serving SMC (within the RAN node 730). In some cases, the AMF 740 may perform steps similar to those in other call flows.

In steps 4a-4b, the serving SMF/SF 750, together with the NG-RAN node 730 with the SMC, determines the sensing mode based on the received capability information (e.g., supported sensing methods, sensing quality of service, and so on). For example, in step 4a, sensing procedures with the involved NG-RAN nodes, such as bistatic sensing where one NG-RAN node may act as a sensing Tx and one or more NG-RAN nodes may act as a sensing Rx, are initiated as described herein. As another example, in step 4b, sensing procedures with the involved NG-RAN nodes and the UE 720 (e.g., bistatic sensing where one NG-RAN node may act as a sensing Tx and one or more UEs may act as a sensing Rx) are initiated as described herein.

In step 5, the SMC collects and processes the sensing measurements from all NG-RAN node(s) and UE(s) and computes the required sensing results. In some cases, the SMC also determines whether the desired sensing QoS/requirements have been met or not met.

In step 6, the SMC may forward the sensing results as part of the sensing response to the requesting sensing service entity in the 5GC (e.g., GMLC) or the external sensing client 765.

FIG. 7C depicts a call flow 770 for the ET-SR.

In step 1, one or more internal sensing clients or applications within the UE 720 requests one or more sensing services, triggered internally. related to sensing the target object 710, where each service is associated with sensing requirements or sensing QoS. In step 1a, the UE 720 may transmit one or more sensing requests to the AMF 740 to be shared with the SF/SMF 750 responsible for handling sensing requests (e.g., the LMF or NG-RAN node with SMC).

In step 2, the AMF 740, if available, selects the SF/SMF 750 to coordinate the handling of the sensing requests and sensing related services with the SMC, based on various configurations known by the SMC/SF/SMF/NF.

In step 3, once selected, the AMF 740 forwards the sensing request to the serving SF/SMF 750.

In steps 4a-4b, the serving SMF/SF 750, together with the NG-RAN node 730 with the SMC, determines the sensing mode based on the received capability information (e.g., supported sensing methods, sensing quality of service, and so on). For example, in step 4a, sensing procedures with the involved NG-RAN nodes, such as bistatic sensing where one NG-RAN node may act as a sensing Tx and one or more NG-RAN nodes may act as a sensing Rx, are initiated as described herein. As another example, in step 4b, sensing procedures with the involved NG-RAN nodes and the UE 720 (e.g., bistatic sensing where one NG-RAN node may act as a sensing Tx and one or more UEs may act as a sensing Rx) are initiated as described herein.

In step 5, the SMC collects the sensing measurements from all NG-RAN node(s) and UE(s) and computes the required sensing results. In step 5a, the NG-RAN node 730 with the SMC collects all or part of the sensing measurements and computes the sensing results. In step 5b, the SF/SMF 750 collects all or part of the sensing measurements and computes the sensing results. In some cases, the NG-RAN node 730 or the SF/SMF 750 determines whether the desired sensing QoS/requirements have been met or not met.

In step 6, the RAN node 730 or the SF/SMF 750 transmits the sensing response. For example, in step 6a, the RAN node 730 transmits the sensing response to the UE 720. The sensing response may include the sensing results and/or techniques used to derive the result. In step 6b, the SF/SMF 750 transmits the sensing response to the UE 720. The sensing response may include the sensing results and/or techniques used to derive the result.

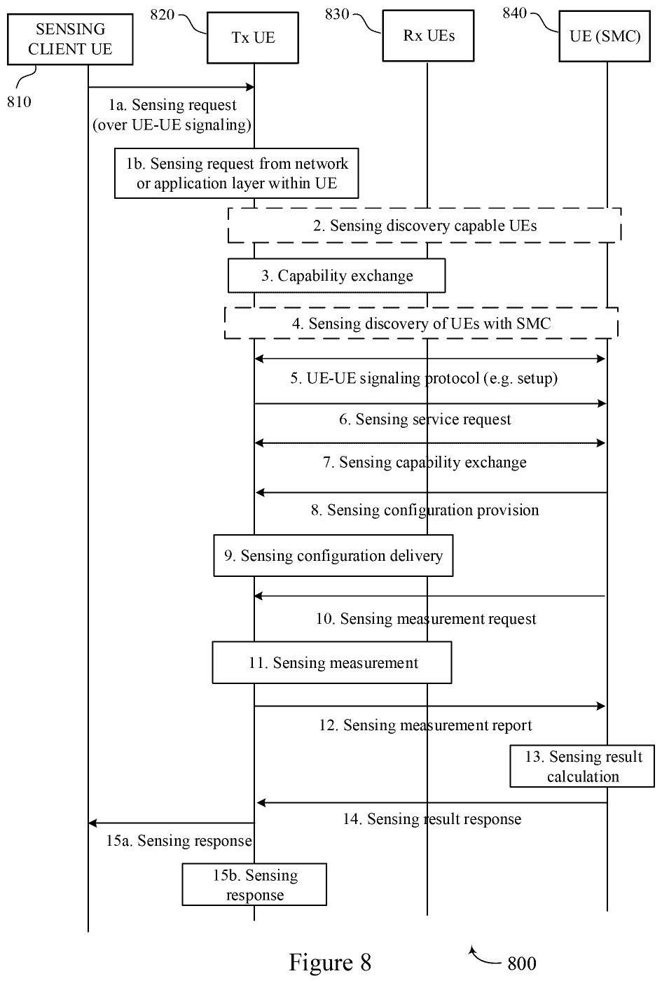

FIG. 8 illustrates an example diagram that depicts a call flow procedure 1200 for an SMC within a UE in accordance with aspects of the present disclosure. The call flow procedure 800 may include communications between a sensing client UE 10, a Tx UE 820, or UE-1, one or more Rx UEs 830, or UE-2, and a UE 840 having an SMC.

In step 1a, the Tx UE 820 may receive a sensing request along with an associated sensing QoS of a target object (or objects) from the client UE 810. The request may include permissions and authentications to request for sensing results from another device or UE.

In step 1b, the TX UE 820 may receive a UE-only sensing request along with an associated sensing QoS of the target object from the application layer (with associated information) or from the network via prior signaling.

In step 2, the TX UE 820 performs discovery of sensing capable UEs/devices including the RX UE 830 (or multiple RX UEs) and the UE 840 having the SMC functionality.

In step 3, when the TX UE 820 is capable of acting as a UE with SMC, the Tx UE 820 proceeds to request and receive the sensing capabilities of the RX UEs 830, or vice versa. In some cases, the UEs may exchange static sensing or absolute positions with each other.

In step 4, when the TX UE 820 is not capable of acting as a UE with SMC, the Tx UE 820 to perform another discovery procedure in search of a UE with SMC capabilities. Once discovered, the Tx UE 820 selects the UE 840 having the SMC as part of the UE-only sensing procedures.

In step 5, if the Tx UE 820 has SMC functionality, it establishes a secure UE-UE signaling link (e.g., a PC5 link) with the Rx UE 830, else it establishes the secure link with the UE 840.

In step 6, the Tx UE 820 transmits the sensing service request of a target object/being with the sensing requirements/KPIs via a UE-UE signaling protocol (e.g., PC5, SLPP, Sensing Protocol (SP)).

In step 7, the UE 840 transmits the sensing capability request to all participating UEs (e.g., TX UE 820 to RX UE 830 via UE-UE a signaling protocol). The UE 840 may also determine the required sensing mode of operation (e.g., monostatic or bistatic or multi-static configurations), supported sensing methods, sensing quality of service, and so on.

In step 8, the UE 840 sends sensing assistance data/information for all RX UEs to the Tx UE 820.

In step 9, the Tx UE 820 sends the received sensing assistance data/information to all RX UEs.

In step 10, the UE 840 sends a request for sensing-related measurements to all UEs (e.g., the Tx UE 820 and the Rx UE 830). In some cases, the Tx UE 820 can receive the request to collect the measurements of all participating UEs.

In step 11, the UEs perform the requested sensing-related measurements of a target object/being.

In step 12, the UEs transmit the sensing-related measurements of the target object/being to the UE 840. In some cases, the RX UE 830 provides the TX UE 820 with the sensing-related measurements and then the Tx UE 820 transmits a consolidated measurement report of all UEs to the UE 840.

In step 13, the UE 840 performs sensing result calculation of the target object/being based on the received sensing-related measurements. In some cases, the UE 840 also determines whether the desired sensing QoS/requirements have been met or not met.

In step 14, the UE 840 transmits the final sensing result of the target object/being to the Tx UE 820 along with the quality of the sensing result and whether it matches any desired requirements/KPIs indicated by the sensing request.

In step 15, the Tx UE 820 transmits the received sensing results for the target object. For example, in step 15a, the Tx UE 820 transmits a sensing response of the target object/being to the sensing client UE 710. As another example, the Tx UE 820, in step 15b, transmits a UE-only sensing response of the target object/being to the application layer (with associated information) or from the network via prior signaling.

In some embodiments, a new or enhanced sensing protocol may be established between a RAN node with SMC and one or more sensing UEs. Such a protocol may be implemented in bistatic sensing operations, where the RAN node is a sensing Tx node and a UE is a sensing Rx node.

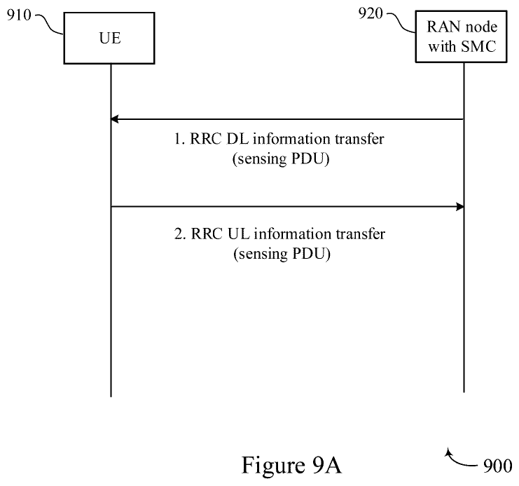

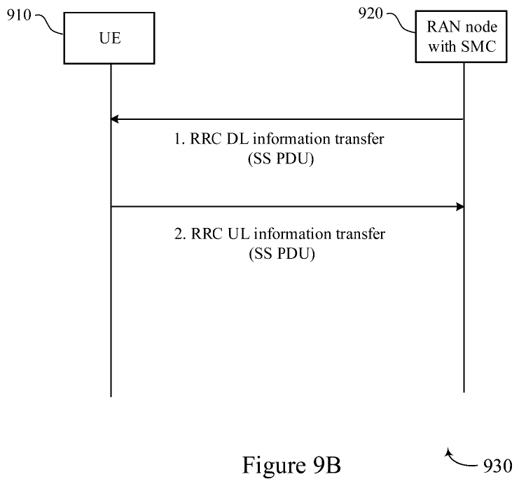

FIGS. 9A-9B illustrate example diagrams that depict signaling between a UE and a RAN having an SMC in accordance with aspects of the present disclosure. For example, FIG. 9A depicts signaling 900 between a UE 910 and a RAN node 920 (with SMC functionality). The signaling 900 presents the use of resource radio control (RRC) as a container to carry sensing-related information between the UE 910 and the RAN node 920.

In some cases, a dedicated sensing protocol may be used or reused for sensing-related signaling between an SMC and sensing target object/being of interest that is transported in an RRC message container. The RRC DL and UL Information Transfer messages may be enhanced to support a non-NAS message container, or a new UL/DL RRC Transfer container message can be defined.

In some cases, sensing-related information may be directly carried using RRC signaling or messages and explicit RRC IEs according to the architecture of an NG-RAN with SMC, The use of RRC may enable the use of further lower layer signaling mechanisms, such as DL/UL, downlink control information (DCI), uplink control information (UCI), DL/UL MAC CE, and/or signaling to carry the sensing-related information in a low latency manner.

FIG. 9B depicts signaling 930 between the UE 910 and the RAN node 920 (with SMC functionality). The signaling 930 presents the use of resource radio control (RRC) as a container to carry supplementary service (SS) messages containing sensing-related information between the UE 910 and the RAN node 920. In some cases, a service that modifies or supplements a basic telecommunication service (e.g., a sensing-related service or a localization/positioning-related service) is referred to as a supplementary service. Thus, in such cases, it may not be offered to a user as a standalone service, and instead is offered together with or in association with a basic telecommunication service. The same supplementary service may be common to a number of basic telecommunication services.

For example, MT-SR and MO-SR services messages may be exchanged between an AMF and a UE and can also be used for sensing function/sensing management location services. Thus, the UE 910 and RAN node 920 may exchange SS messages for support of periodic and triggered sensing services. In some cases, such as for the RAN node 920 the SS messages can be transported in the RRC container messages depicted in the signaling 900. In some cases, SS messages carrying sensing-related information may be directly carried using RRC signaling or messages and explicit RRC IEs according to the architecture of NG-RAN with SMC.

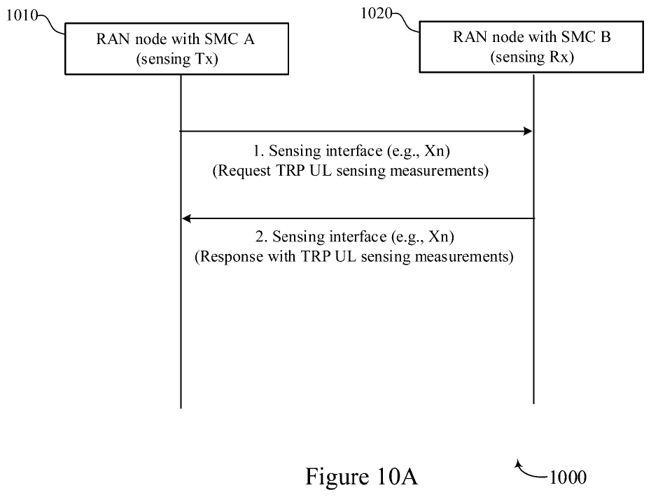

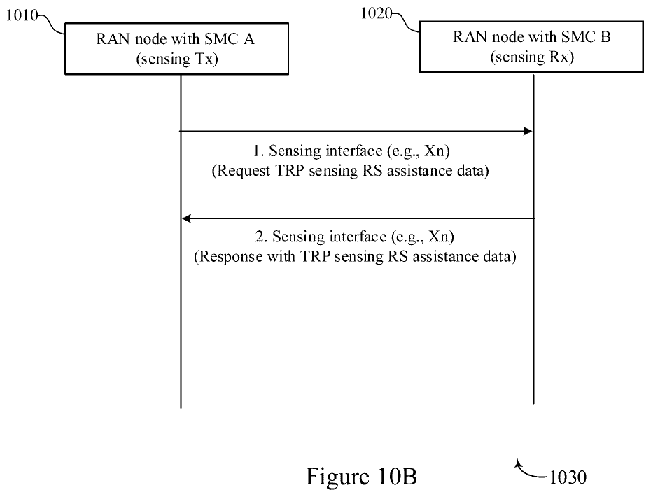

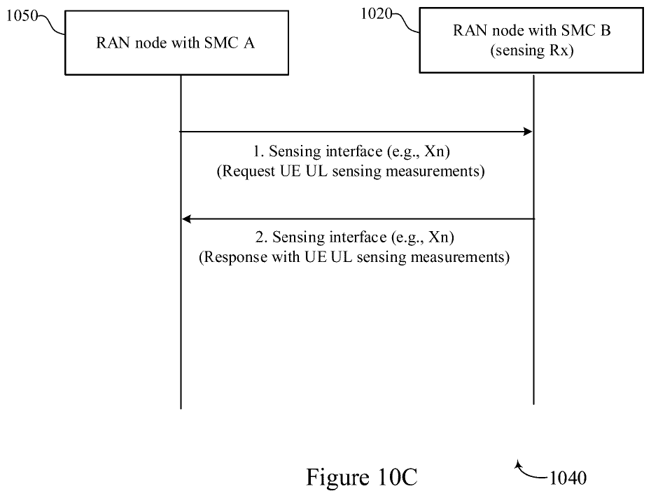

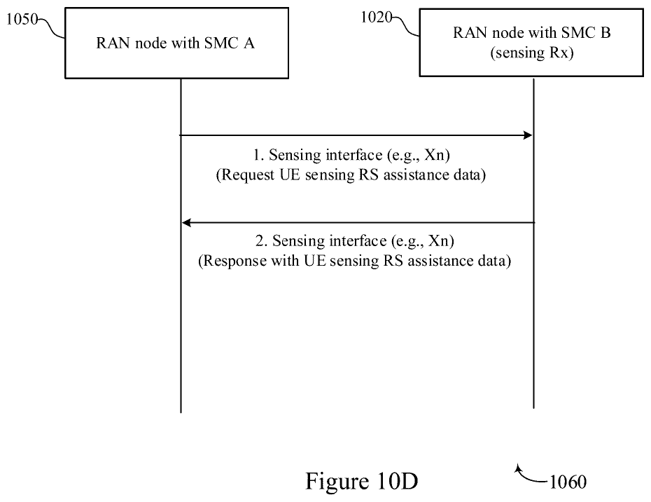

In some embodiments, a new or enhanced sensing protocol may be established between two RAN nodes (one as a sensing Tx and one as a sensing Rx). FIGS. 10A-10D illustrate example diagrams that depict signaling between RAN nodes having an SMC in accordance with aspects of the present disclosure.

The sensing procedures between pairs of NG-RAN nodes (with SMCs) may support one or more of the following functions:

As shown in signaling 1000 of FIG. 10A: Request UL sensing measurements from one NG-RAN node with SMC A 1010 to another NG-RAN node with SMC B 1020, where the NG-RAN node with SMC A 1010 may act as a sensing Tx and the NG-RAN node with SMC B 1010 may act as a sensing Rx;

As shown in signaling 1030 of FIG. 10B: Request sensing assistance data (including TRP information and/or sensing RS configurations) from the NG-RAN node with SMC A 1010 to the NG-RAN node with SMC B 1020, where the NG-RAN node with SMC A 1010 may act as a sensing Rx and the NG-RAN node with SMC B 1020 may act as a sensing Tx;

As shown in signaling 1040 of FIG. 10C: Request UL sensing measurements from the NG-RAN node with SMC A 1010 to the NG-RAN node with SMC B 1020, where a UE may act as a sensing Tx and the NG-RAN node with SMC B 1020 may act as a sensing Rx, and/or Request a change in sensing RS broadcast scheduling and configuration by a NG-RAN node with SMC to a neighbor NG-RAN node with SMC; and/or

As shown in signaling 1050 of FIG. 10D: Request sensing assistance data (including sensing RS configurations) from the NG-RAN node with SMC A 1010 to the NG-RAN node with SMC B 1020, where a UE may act as a sensing Tx and the NG-RAN node with SMC A 1010 may act as a sensing Rx.

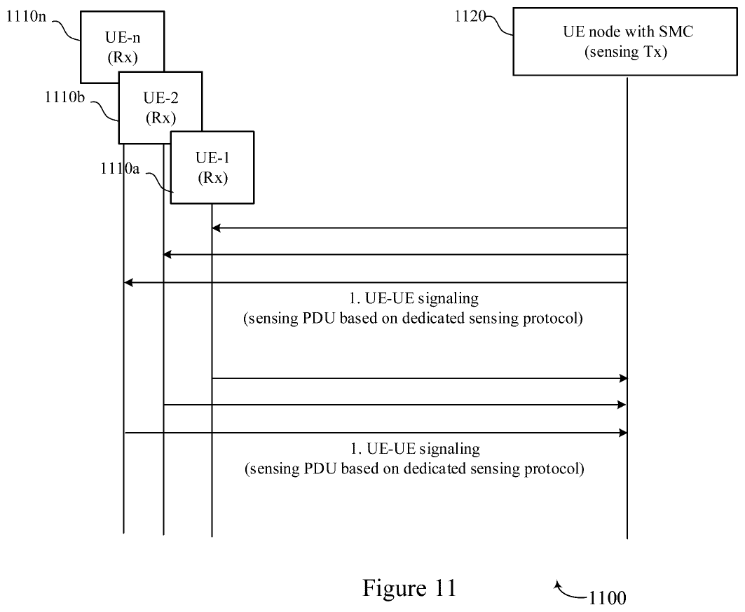

In some embodiments, a new or enhanced sensing protocol may be established between a UE with SMC (as a sensing Tx) and a UE (as a sensing Rx). FIG. 11 illustrates an example diagram that depicts signaling 1100 between a UE 1120 having an SMC and other UEs 1110a-n in accordance with aspects of the present disclosure.

The UE 1120, acting as a serving or lead UE, may utilize new or enhanced signaling with other UEs, such as UE 1110a, UE 1110b . . . . UE 1110n. Such a protocol may be useful for bistatic sensing operations, where the UE 1120 acts as a sensing Tx node and the UEs 1110a-n act as sensing Rx nodes.

In some cases, the transfer of sensing-related information between UEs may include unicast (one-to-one), groupcast (secured one-to-many) or broadcast (unsecured one-to-many) between one or more UEs/devices.

In some embodiments, a dedicated sensing protocol may be used or reused for sensing-related signaling between an SMC and target sensing object/being of interest and transported in an SLPP or supplementary service message container. SLPP messages may be enhanced to support transfer of sensing-related information, as shown in FIG. 11. In some cases, sensing-related information may be directly carried using existing PC5 signaling/messages and explicit PC5 (SL) IEs according to the architecture of UE with SMC. In some cases, the enhanced protocol enables use of further lower layer signaling mechanisms, such as 1^{st} or 2^{nd} stage sidelink control information (SCI), physical sidelink shared channel (PSSCH,) physical sidelink control channel (PSCCH), or sidelink medium access control control element (SL MAC CE), to carry the sensing-related information in a low latency manner.

In some embodiments, the S-intf may handle possible NG-RAN node sensing capability information, sensing RS configuration messages from SMC to NG-RAN node(s), sensing measurement requests and collection procedures, and error handling information regarding assistance data and performing sensing measurements. Further, the S-intf may handle the following:

Interface management function(s) to allow for initial setup of the interface, exchange/update of application-level data, and so on;

Message transfer function(s) to allow transfer of sensing-related messages, including Request (from SMC to TRP) and Provide Sensing Capabilities (from TRP to SMC), TRP Sensing Information Request (from SMC to TRP) and TRP Information Response messages or TRP Information Failure messages (from TRP to SMC), Sensing Information Request (from SMC to TRP) and Sensing Information Response messages or Sensing Information Failure messages (from TRP to SMC), and so on.

In some embodiments, the systems and methods may implement coordination procedures between a centralized SMF/SF/NF responsible for handling sensing requests (e.g., an LMF) and an NG-RAN node with SMC.

For example, an AMF initiates (in case of NI-SR) or receives (in cases of RI-SR, MO-SR, and MT-SR) a sensing request, and selects an SMF/SF/NF to handle sensing requests, such as perform the sensing of one or more target sensing objects/beings of interest. The AMF may consider various factors during selection, including: requested Sensing Quality of Service information (e.g., distance accuracy, latency, shape accuracy, tracking accuracy), the SMF/SF/NF responsible for handling sensing requests, capabilities, load status of the SMF/SF/NF handling sensing requests, location and AMF local configuration related to the SMF/SF/NF.

For a given target sensing object/being of interest, only one SMF/SF/NF may be active to manage the overall coordination and scheduling of resources required for the sensing of the target object/being of interest. The AMF also supports re-selection of the SMF/SF/NF, such as when the currently active SMF/SF/NF is in use and cannot be used for a newly initiated/received sensing request.

In some cases, in order to integrate the SMC into the overall sensing architecture, the AMF may be aware that the NG-RAN node supports SMC and may also be aware of some of its capabilities. The NG-RAN node may explicitly transmit its capabilities to the AMF upon request (e.g., based on a solicitation message) or based on an unsolicited request. In some cases, this capability of the SMC at the NG-RAN node may be configured to the AMF via OAM.

In some embodiments, sensing service levels may be defined with corresponding performance requirements (e.g., positioning estimate sensing accuracy, velocity estimate accuracy, sensing resolution, sensing service latency, refresh rate, and so on). In some cases, different sensing service requests with stringent requirements may be managed and coordinated between a SMF/SF/NF responsible for handling sensing requests and the SMC.

In some cases, the AMF selects the SMC for only certain sensing requests (e.g., those requiring stringent sensing QoS, such as low latency and/or high sensing accuracy) and selects an LMF or other CN function for all other location or sensing requests (e.g., those requiring normal sensing QoS).

In some cases, such as when there are concurrent sensing requests for the same target object/being of interest, and least one sensing requires stringent QoS, various methods may be employed, including:

Method A—Concurrent sensing requests are all handled by a single entity (e.g., the SMC), irrespective of the sensing QoS. Thus, concurrent sensing requests are handled by the same sensing management entity (e.g., the SMC). A new sensing request is transferred to the SMF/SF/NF, and the SMC handles an ongoing sensing session when an SMF/SF ID is available in the target object/sensing context stored in the AMF. In the case of the SMC, the target object/sensing context indicates that there is an SMC handling an ongoing location session, and therefore concurrent location requests are transferred by the AMF to the SMC.

In some cases, an ongoing sensing session may be transferred from the SMC to the SMF/SF/NF when there are unexpected issues during an ongoing SMC session, enabling the SMC to handle concurrent sensing requests in a coordinated and efficient way; and/or

Method B—Parallel sensing requests requiring stringent QoS are handled by the SMC, while the other sensing requests are handled in parallel by an SMF/SF/NF. Thus, different sensing requests for the same target object/being are handled concurrently by two sensing management entities: the SMC and an SMF/SF/NF. The AMF provides enhanced information about the location or sensing request(s) being handled by the SMC to the SMF/SF/NF, in order to manage parallel sensing requests for the same target object/being.

For example, the SMF/SF/NF may retrieve the latest or most updated sensing result of the target object/being from the SMC if the ongoing sensing session has certain sensing QOS requirements (e.g., accuracy, resolution, latency, and so on), or the SMF/SF/NF may handle the concurrent sensing request in an independent way that does not conflict with the SMC. Thus, when the parallel sensing request does not require a certain sensing QoS, the SMF/SF/NF is able to satisfy the request with less accurate sensing methods that do not conflict or overlap with the methods used by the SMC. Such deployment flexibility enables the use of the SMC for sensing requests that require stringent sensing QoS, while less demanding sensing requests continue to be served by the SMF/SF/NF in the core network.

In some embodiments, a new dedicated interface between SMCs and an SF/SMF/NF may support message transfer and signaling related to sensing information and related coordination information between the SMC and the SMF. For example, the coordination information may include the capability of the SF/SMF/NF to select between multiple SMCs, depending on the coverage of the one or more target sensing object(s)/being(s) of interest. As another example, the sensing information may include sensing reference signal configuration request messages as well as measurement request messages and associated response messages from these requests.

Therefore, the following functions may be considered with respect to indirect/direct interface/messages between a direct centralized SF/SMF/NF and multiple SMCs: selecting suitable SMCs, managing concurrent/parallel sensing requests with same or different sensing QoS/requirements, exchanging sensing capabilities of various UEs/network nodes/NG-RAN nodes, supporting selection of serving SMCs with associated NG-RAN node for periodic or triggered location requests, exchanging sensing RS configurations, exchanging sensing measurement configurations and reports, exchanging any related error-related messages/abort messages, supporting exchange of control plane or user plane sensing-related information as well as selection of either control plane or user plane messages, and so on.

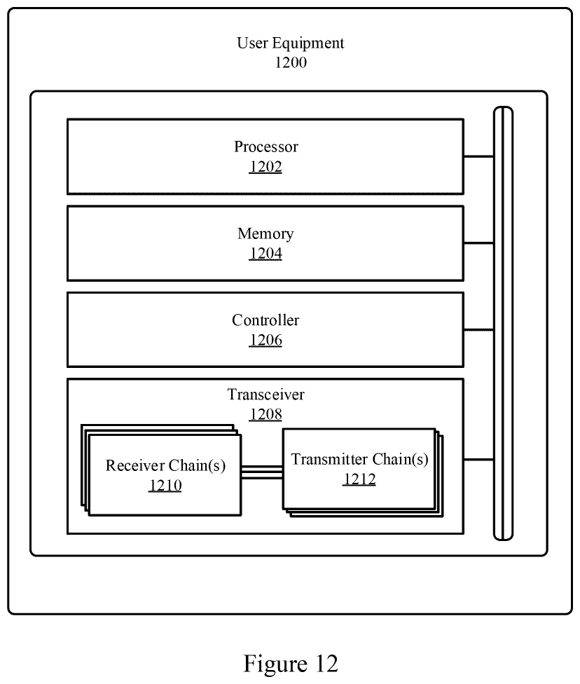

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receive the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

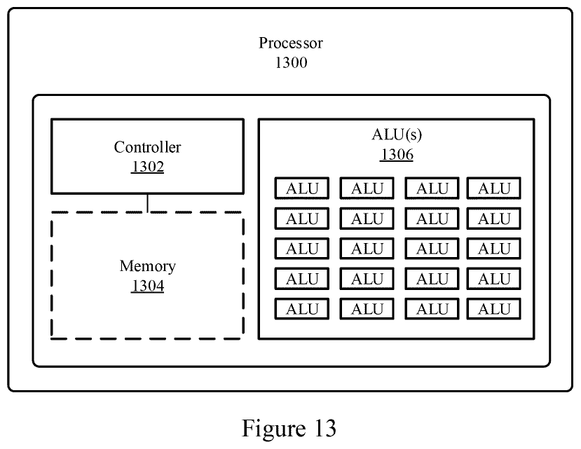

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory address of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, arithmetic logic units (ALUs), and other functional units of the processor 1300.

The memory 1304 may include one or more caches (e.g., memory local to or included in the processor 1300 or other memory, such RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, the controller 1302, and the memory 1304 may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein.

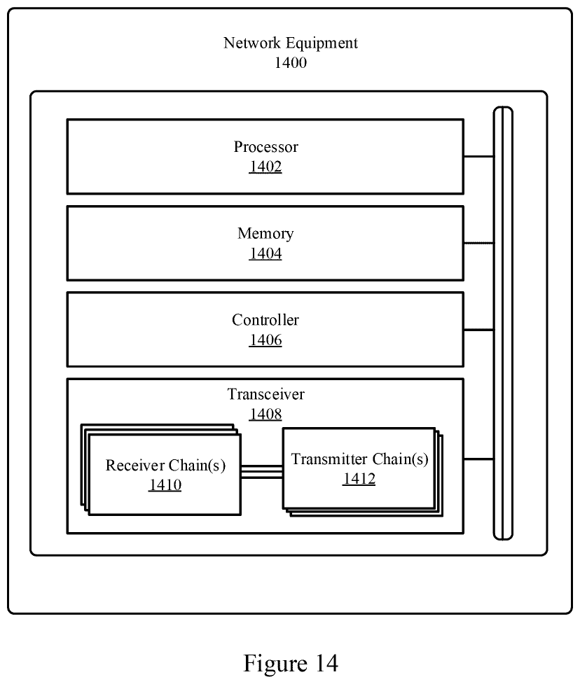

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404).

For example, the processor 1402 may support wireless communication at the NE 1400 in accordance with examples as disclosed herein. The NE 1400 may be configured to support a means for receiving a request to perform a sensing operation, wherein the request identifies a request type and a sensing QoS, determining a sensing mode for the sensing operation based on the request type, transmitting one or more sensing reference signal configurations to one or more RANs, and receiving, from the one or more RANs, sensing measurements based on the one or more RANs performing the sensing operations.

As another example, the NE 1400 may be configured to support a means for receiving a request to perform a sensing operation from a RAN, transmitting one or more sensing reference signal configurations to one or more RANs in response to the received request, and receiving, from the one or more RANs, sensing measurements based on the one or more RANs performing the sensing operations.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas for receive the signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the processing the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

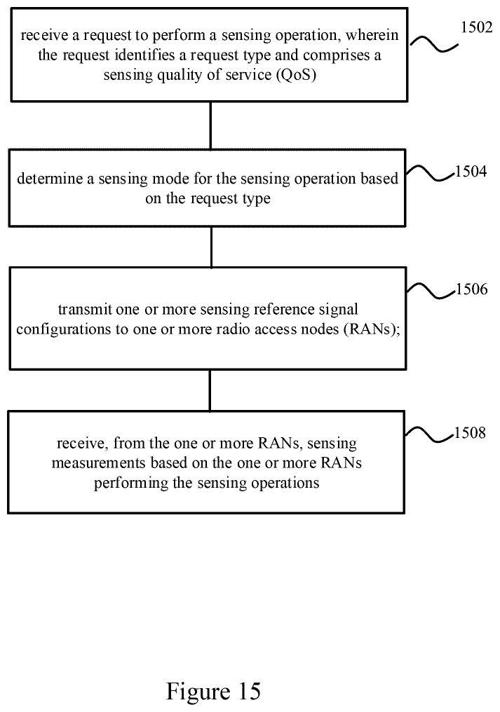

FIG. 15 illustrates a flowchart of a method in accordance with aspects of the present disclosure. The operations of the method may be implemented by an NE as described herein. In some implementations, the NE may execute a set of instructions to control the function elements of the NE to perform the described functions.

At 1502, the method may include receiving a request to perform a sensing operation, wherein the request identifies a request type and a sensing QoS. The operations of 1502 may be performed in accordance with examples as described herein. In some implementations, aspects of the operations of 1502 may be performed by an NE as described with reference to FIG. 14.

At 1504, the method may include determining a sensing mode for the sensing operation based on the request type. The operations of 1504 may be performed in accordance with examples as described herein. In some implementations, aspects of the operations of 1504 may be performed by an NE as described with reference to FIG. 14.

At 1506, the method may include transmitting one or more sensing reference signal configurations to one or more RANs. The operations of 1506 may be performed in accordance with examples as described herein. In some implementations, aspects of the operations of 1506 may be performed by an NE as described with reference to FIG. 14.

At 1508, the method may include receiving, from the one or more RANs, sensing measurements based on the one or more RANs performing the sensing operations. The operations of 1508 may be performed in accordance with examples as described herein. In some implementations, aspects of the operations of 1508 may be performed by an NE as described with reference to FIG. 14.

It should be noted that the method described herein describes a possible implementation, and that the operations and the steps may be rearranged or otherwise modified and that other implementations are possible.

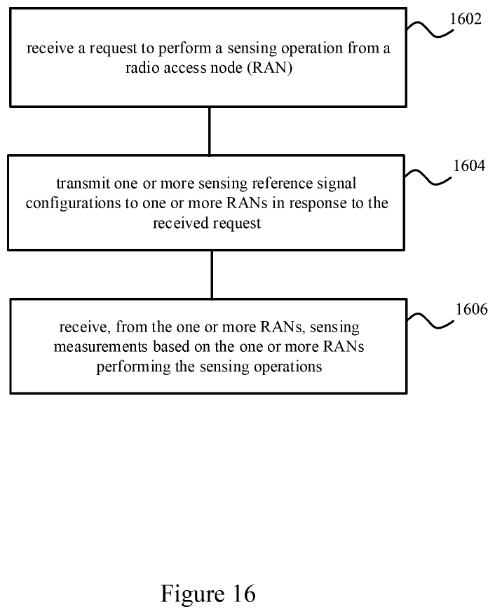

FIG. 16 illustrates a flowchart of a method in accordance with aspects of the present disclosure. The operations of the method may be implemented by an NE as described herein. In some implementations, the NE may execute a set of instructions to control the function elements of the NE to perform the described functions.

At 1602, the method may include receiving a request to perform a sensing operation from a RAN. The operations of 1602 may be performed in accordance with examples as described herein. In some implementations, aspects of the operations of 1602 may be performed by an NE as described with reference to FIG. 14.

At 1604, the method may include transmitting one or more sensing reference signal configurations to one or more RANs in response to the received request. The operations of 1604 may be performed in accordance with examples as described herein. In some implementations, aspects of the operations of 1604 may be performed an NE as described with reference to FIG. 14.

At 1606, the method may include receiving, from the one or more RANs, sensing measurements based on the one or more RANs performing the sensing operations. The operations of 1606 may be performed in accordance with examples as described herein. In some implementations, aspects of the operations of 1606 may be performed an NE as described with reference to FIG. 14.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network function for wireless communication, comprising:
at least one memory; and
at least one processor coupled with the at least one memory and configured to cause the network function to:
receive a request to perform a sensing operation,
wherein the request identifies a request type and comprises a sensing quality of service (Qos);
determine a sensing mode for the sensing operation based on the request type;
transmit one or more sensing reference signal configurations to one or more radio access nodes (RANs); and
receive, from the one or more RANs, sensing measurements based on the one or more RANs performing the sensing operations.

2. The network function of claim 1, wherein the at least one processor is further configured to cause the network function to:
determine a sensing result based on the sensing measurements received from the one or more RANs; and
transmit the determined sensing result to an entity that requested the sensing operation.

3. The network function of claim 1, wherein the request type includes:
a RAN induced sensing request (RI-SR);
an entity terminated sensing request (ET-SR);
a mobile originated sensing request (MO-SR);
a network induced sensing request (NI-SR);
a deferred sensing request;
a user equipment (UE) sensing request (UE-SR);
or combinations thereof.

4. The network function of claim 3, wherein the RI-SR comprises sensing operations for RAN functions.

5. The network function of claim 1, wherein the sensing QoS comprises:
sensing accuracy;
detection range resolution,
range accuracy,
direction or angle accuracy,
doppler resolution and accuracy,
update rate,
beamwidth,
false alarm rate,
probability of detection,
clutter rejection metrics,
coverage area,
azimuth or elevation coverage,
sensing response time,
sensing latency metrics,
sensing reliability metrics,
or combinations thereof.

6. The network function of claim 1, wherein the network function includes a sensing management component (SMC).

7. The network function of claim 1, wherein the network function is a location management function (LMF) that manages requests to perform sensing operations.

8. The network function of claim 1, wherein the network function is a RAN node performing sensing transmissions during the sensing operations and exchanges information with a user equipment (UE) performing sensing reception during the sensing operations via UE-RAN signaling mechanisms.

9. The network function of claim 1, wherein the network function is a RAN node performing sensing transmissions during the sensing operations and exchanges information with a different RAN node performing sensing reception during the sensing operations via RAN-RAN signaling mechanisms.

10. The network function of claim 1, wherein the at least one processor is configured to cause the network function to transmit one or more sensing reference signal configurations to the one or more RANs via a message transfer function that supports capability exchange, transmission-reception point (TRP) information exchange, or sensing information exchange.

11. The network function of claim 1, wherein the network function is an access and mobility management function (AMF) and selects a RAN node, from the one or more RANs, which includes a sensing management component (SMC) to manage requests to perform sensing operations.

12. The network function of claim 1, wherein the at least one processor is configured to cause the network function to:
transmit a first sensing reference signal configuration to a RAN node that includes a sensing management component (SMC) when the sensing operation is associated with a high sensing QoS; and
transmit a second sensing reference signal configuration to a function of a core network (CN) when the sensing operation is associated with a low sensing QoS.

13. The network function of claim 1, wherein the at least one processor is configured to cause the network function to transmit the one or more sensing reference signal configurations to a RAN node and centralized network function of a core network (CN).

14. A method performed by a network function, the method comprising:
receiving a request to perform a sensing operation,
wherein the request identifies a request type and a sensing quality of service (QoS);
determining a sensing mode for the sensing operation based on the request type;
transmitting one or more sensing reference signal configurations to one or more radio access nodes (RANs); and
receiving, from the one or more RANs, sensing measurements based on the one or more RANs performing the sensing operations.

15. The method of claim 14, further comprising:
determining a sensing result based on the sensing measurements received from the one or more RANs; and
transmitting the determine sensing result to an entity that requested the sensing operation.

16. The method of claim 14, wherein the request type includes:
a RAN induced sensing request (RI-SR);
an entity terminated sensing request (ET-SR);
a mobile originated sensing request (MO-SR);
a network induced sensing request (NI-SR);
a deferred sensing request;
a user equipment (UE) sensing request (UE-SR);
or combinations thereof.

17. The method of claim 16, wherein the RI-SR comprises sensing operations for RAN functions.

18. A network function for wireless communication, comprising:
at least one memory; and
at least one processor coupled with the at least one memory and configured to cause the network function to:
receive a request to perform a sensing operation from a radio access node (RAN);
transmit one or more sensing reference signal configurations to one or more RANs in response to the received request; and
receive, from the one or more RANs, sensing measurements based on the one or more RANs performing the sensing operations.

19. The network function of claim 18, wherein the network function is a sensing management component (SMC) that receives a RAN induced sensing request (RI-SR) from the RAN.

20. A method performed by a network function, the method comprising:
receiving a request to perform a sensing operation from a radio access node (RAN);
transmitting one or more sensing reference signal configurations to one or more RANs in response to the received request; and
receiving, from the one or more RANs, sensing measurements based on the one or more RANs performing the sensing operations.
